(19) United States
(12) Patent Application Publication
(10) Pub. No.: US 2008/0301361 A1
(43) Pub. Date: Dec. 4, 2008

(54) Dedicated flow manager between the processor and the random access memory

(76) Inventor: Michael Vergoz, Sainte Rose (FR)

Correspondence Address: TOURET, 103ter allee des aubepines, Saint Pierre, 97410, FR

(21) Appl. No.: 12/154,819

(22) Filed: May 28, 2008

(30) Foreign Application Priority Data
Oct. 28, 2005 (FR) FR0511043
Oct. 20, 2006 (FR) PCT/FR2006/002357

(51) Int. Cl. G06F 12/00

(52) U.S. Cl. 711/104; 711/E12.001

(57) ABSTRACT

The invention proposes a flow manager between the main processor and the random access memory that improves performances and security with a memory access management interface processor positioned in interface between the main processor and the random access memory, this memory access management interface processor selecting the relevant flow characteristics with which it feeds an interface dedicated storage unit, the interface dedicated storage unit being only accessible by the memory access management interface processor, the embodiment of this invention may be either hardware or logic.

The present invention relates to a method and its associated digital flow burn-in devices between a processor and random access memories. In particular, the invention finds its application in the industrial data processing and electronics fields.

### BACKGROUND OF THE INVENTION

To execute a program, it is necessary to have both a processor and a random access memory that, in a special form, is known by the designation RAM. The processor houses a computing space and a memory space called the register. Random access memory houses four types of memory, including real/dynamic memory, real/linear memory, virtual/dynamic memory and virtual/linear memory. A real space is housed in the random access memory. Real space is space known as non-bridged space; it directly accesses the RAM without going through an address translation. Unlike real space, virtual space must go through an address translation known as a bridge to enable it to physically access the random access memory. Access to the memory from a virtualized space necessarily goes through a real space. Core logic, also known as an operation or operating system, operates in real mode or in real space. A core logic task, core logic process or even an application operates in virtual mode or in a virtual space. Some of these spaces are dynamic. Others are linear. Dynamic spaces do not necessitate permission specifications. Linear spaces are spaces where it is possible to specify the permissions.

On the motherboard, the processor and random access memory interact according to a series of instructions and functions. They exchange data containing memory addresses that are allocated by the processor and housed either in a processor register or in the random access memory. This dialogue presents numerous malfunctions. The main malfunctions are the execution of a memory address that should not be executed, the reading of a memory address that should not be read and the writing in a memory address that should not be written.

Pagination is a memory management device between the processor and the random access memory. Pagination enables the processor to allocate memory zones. A memory zone is defined by a memory address and by the requested size. Pagination also enables access permission to these memory zones to be managed. Permissions are of the executable, reading or writing type. A defect in this pagination method is that it is difficult to make the memory addresses enabling access to the random access memory totally random. In fact, the system is not provided for this purpose and will block and/or take up too much memory space on the random access memory.

Thus it is obvious that the dialogue system between the processor and the random access memory is extremely complex.

It should be noted that in current processors, the act of obtaining the reading permission indicates execution permission. An extremely common defect in program execution is the instruction execution stored in a memory zone normally expected to only be accessible by reading. Some producers from the prior art attempt to mitigate this problem by adding execution control bits to the conventional memory system. This proved to be insufficient since the pagination system does not make the memory addresses totally random.

### BRIEF DESCRIPTION OF THE INVENTION

One main object of the invention is to secure the executions, reading and writing between the processor and the random access memory. In particular, memory overflows, being a known source of failure, are blocked by the invention.

One object of the invention is to optimize the memory allocation requests made by the processor. These allocation requests are real/dynamic or real/linear or virtual/dynamic or virtual/linear.

One object of the invention is to facilitate memory management by the processor. This invention promotes operation system development and opens new possibilities to simultaneously launch several operation systems in a totally transparent manner.

One object of the invention is to create a new memory management device between the processor and the random access memory. This device is interoperable or interchangeable with that from the prior art.

One object of the invention is to limit heat effects due to the load necessary for the processor to manage the memory.

One object of the invention is for manufacturers to lower the frequencies of their processors while keeping an equivalent or higher level of performance.

In one main aspect, the invention consists of securing executions, readings and writings between the processor and the random access memory by improved permission management and constraining real or virtual linear allocation tasks.

In one aspect, the invention consists of reshaping the computer allocation system, particularly pagination.

### BRIEF DESCRIPTION OF THE SEVERAL VIEWS OF THE DRAWINGS

The attached figures represent a particular mode of the invention in which:

FIG. 1a represents a basic view of a processor.

FIG. 1b represents a simplified view of a random access memory.

FIG. 1c represents a basic view of memory spaces on the random access memory.

FIG. 2 represents a simplified motherboard according to one particular aspect of the invention.

FIG. 3 represents a particular embodiment in schematic view of a memory access management interface chip (180) according to the invention.

FIGS. 9a, 9b, 9c, 9d, 9e, 9f more particularly describe certain components from FIG. 3

### DETAILED DESCRIPTION OF THE INVENTION

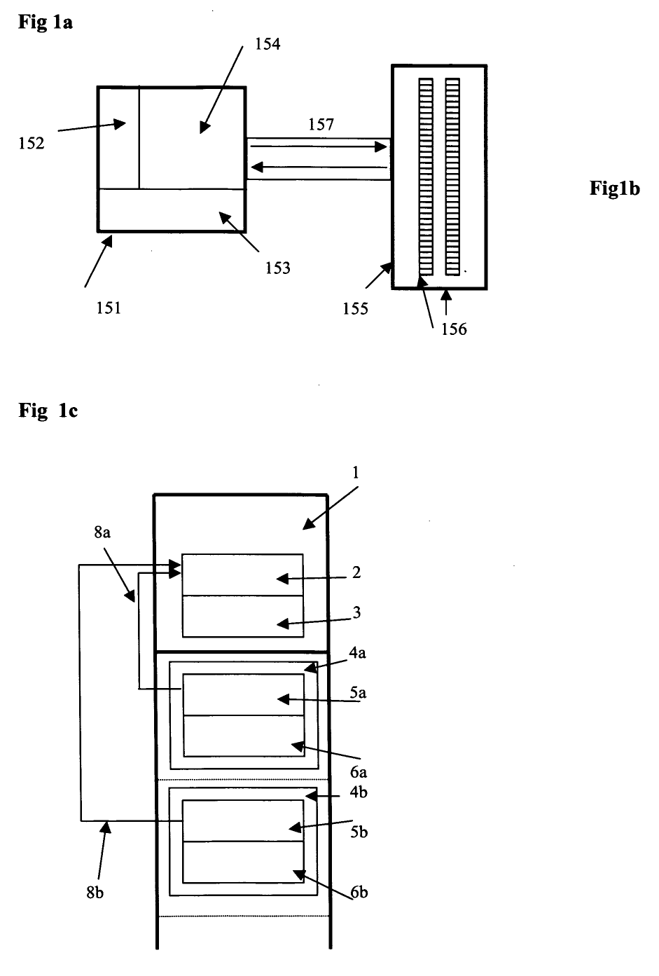

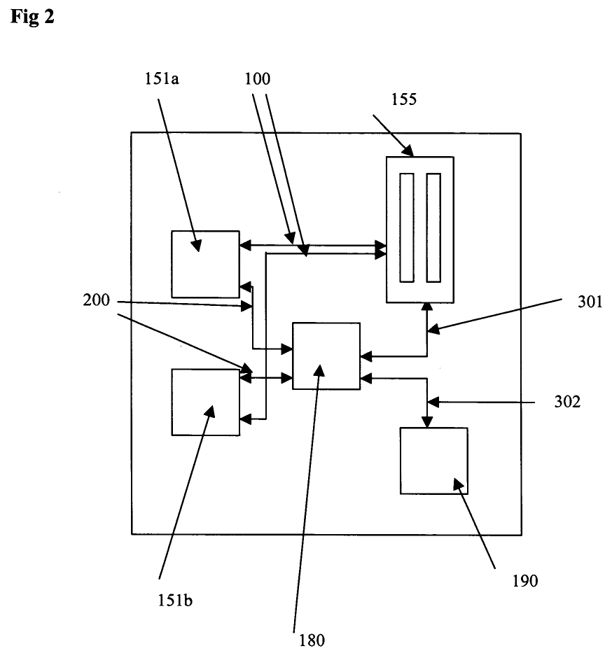

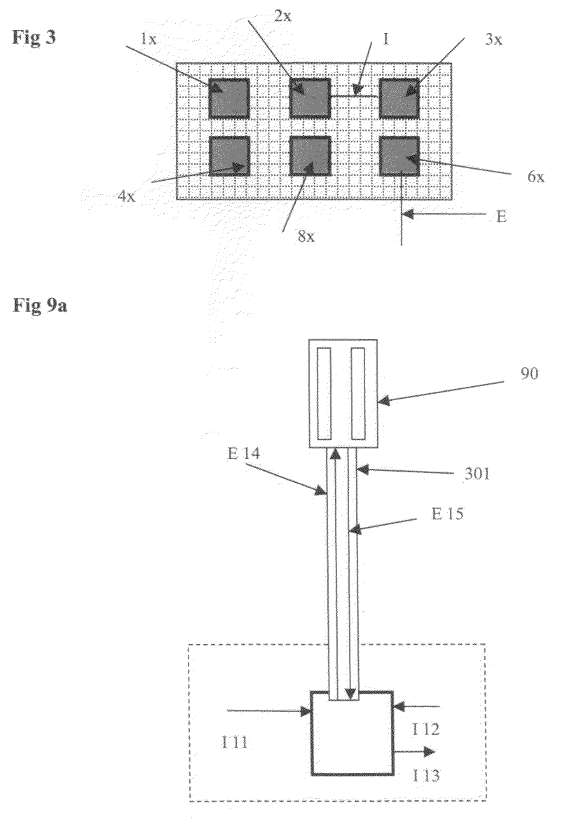

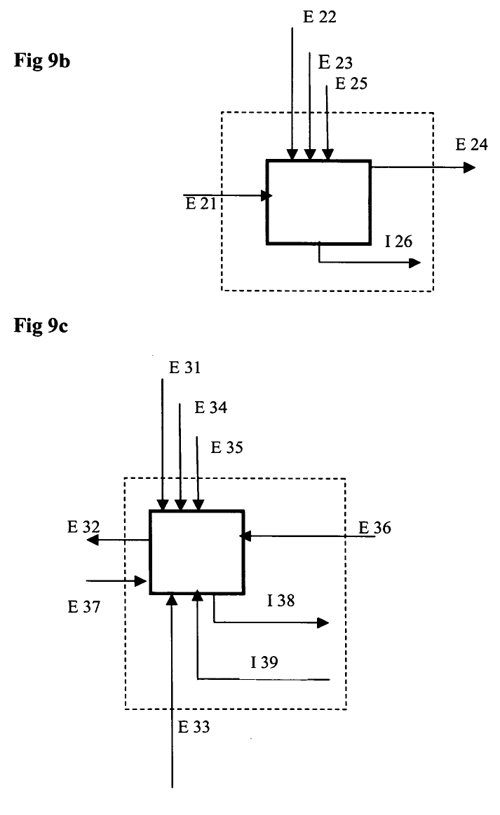

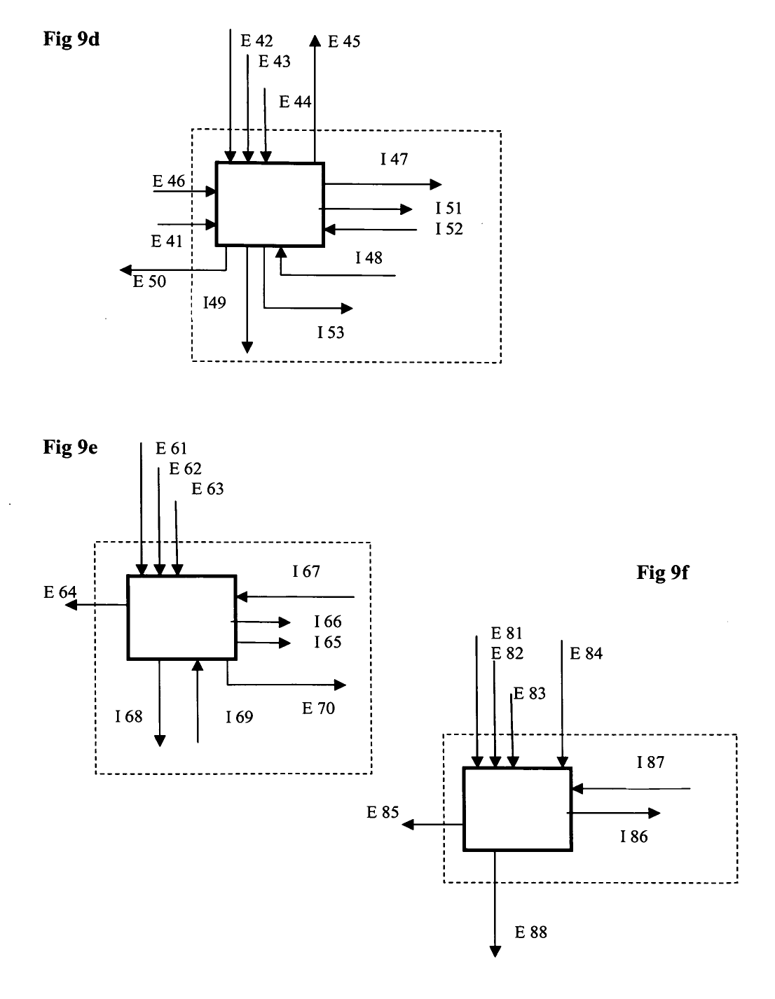

FIGS. 1a and 1b represent a basic view of a main processor (151) and the random memory (155). A main processor (151) is represented that houses a computing space (154) and a memory space known as a register (152) and a buffer memory (153), also known as a cache memory. The main processor (151) interacts with the random access memory (155) that includes modules (156) by means of connections called buses (157). FIG. 1c represents the memory organization on the random access memory (155) memory space. The general organization of the memory from the random access memory (155) is a real space (1) that contains real linear memories (2), real dynamic memories (3) and several virtual spaces (4). Each virtual space (4a, 4b, etc.) corresponds to a process or a processor task. One application may group several processes together. Virtual spaces (4a, 4b, etc.) include a virtual linear space (5a) and a virtual dynamic space (6a). A bridge (8a, 8b, etc.) enables a junction to be established between a virtual address from the virtual space (4a) and a real address in the real space (1). FIG. 2 represents a simplified motherboard according to one particular aspect of the invention. In this example, two processors (151a, 151b) are mounted on the motherboard. Of course, the invention also operates with a single main processor (151) or more than two processors (151). A new processor (180) known as a memory access management interface processor (180) is disposed between the processors (151a, 151b) and the random access memory (155). The memory access management interface processor (180) is in link interface by buses (200) with the main processor (151) for managing the reading, writing and execution validation of a sequence of instructions in the random access memory (155) and by the bus (301) from the random access memory (155). In one option of embodiment, for matters of compatibility with systems from the prior art, a direct link (100) known as a direct bus (100) between the processor (180) and the random access memory (155) is maintained. For security matters, activation of the memory access management interface processor (180) deactivates use of the direct bus (100). Another aspect of the invention consists of the provision of a storage unit (190) dedicated to the storage of specific data processed by the memory access management interface processor (180) known as the interface dedicated storage unit (190). This interface dedicated storage unit (190) is linked with the memory access management interface processor (180) and only with the memory access management interface processor (180) by a bus (302) known as a deadlock bus (302). Of course, physically, for reasons of motherboard manufacturing convenience, this interface dedicated storage unit (190) may be situated in the random access memory. The distinctiveness remains that this interface dedicated storage unit (190) is positioned at the bottom of an electronic deadlock in a single link with the memory access management interface (180). FIG. 3 describes a memory access management interface processor (180) composition that in this case is comprised of six sections (1x, 2x, 3x, 4x, 6x, 8x). These sections each perform a certain type of operation and constrain memory space reading, writing and execution as well as the allocation requests performed by the main processor (151). Data is exchanged between each section. Some data follow internal paths (I) to the memory access management interface processor (180). Some data follow external paths (E); the memory access management interface processor (180) is linked with another processor or another memory. More particularly, section (1x) is a section known as neutral, section (2x) is a processor task management section, section (3x) is a random number generation section, section (4x) is a real and virtual linear allocation section, section (6x) is a real or virtual dynamic allocation section and section (8x) is a section managing access (8x) from the main processor (151) to the random access memory (155). FIG. 9a more particularly represents the neutral section (1x). The neutral section (1x) or section known as secured is a separate memory that enables various data relative to the tasks of the memory access management interface processor (180), the linear addresses created and the dynamic addresses created to be stored. To do this, an internal writing input (I 11) enables the neutral section (1x) to write in the interface dedicated storage unit (190). An internal search request input (I 12) enables the neutral zone (1x) to search for data in the interface dedicated storage unit (190) by the output (E 14) that passes in the deadlock bus (301) and that is restored by the input (E 15) that passes in the deadlock bus (301). The search result is then sent by the search output (I 13). FIG. 9b represents the processor task management section (2x). To enable the device to constrain physical access to the random access memory (155), the main processor (151) must inform the access management of the memory access management interface processor (180) that a virtualized space was created. An external input (E 21) enables the main processor (151) to continuously inform the processor task management section (2x) of the memory access management interface processor (180) of the position of the instruction cursor of the main processor or processors. An input (E 22) enables making a real or virtual task of the processor (151) known by all of the memory access management interface processor (180) through the output (I 26) to the neutral section (1x) by the writing input (I 11). Identification is given through the output (E 24). An input (E 23) enables a real or virtual task from the processor to be destroyed. An input (E 25) gives the task identifier associated with the destruction. Optionally, it is possible, when a task is destroyed, to voluntarily and automatically trigger the destruction of memories attached to the task. Destruction acts in the neutral section (1x) by the writing input (I 11). FIG. 9c represents the random number generation section (3x). To enable the chip to detect memory overflow attempts—of whatever type whatsoever—and thus implement countermeasure actions, it is necessary to provide completely random addresses in order to make undefined addresses or numbers. To do this, one of the inputs (E 31) of the random number generation section (3x) enables requesting it to generate a random number in the output (E 32). Two optional inputs (E 34) and (E 35) may be used to define a range where the random number should be situated. An input (E 33) enables the random number generation section (3x) to be continuously informed of the position of the instruction cursor from the main processor or processors. Another input (E 36) enables requesting the random number generation section (3x) to generate a random number that corresponds to a valid address with relation to the input (E 33). It is associated with the input (E 37) that reports the size that will be used by the future address block. As with the input (E 31), a random number is generated in output (E 32). For processing the input (E 36), it is necessary to consider data from the tasks stored in the interface dedicated storage unit (190) to know if the input (E 33) comes from a virtualized or real space and if the address proposed for the output (E 32) does not collide with another address. All of this is performed through the output (I 38) to (I 12) and through the input (I 39) from (I 13). FIG. 9d represents the real and virtual linear allocation section (4x). An input (E 41) enables the allocation section (4x) to be continuously informed of the position of the instruction cursor from the main processor or processors (151). Three inputs (E 42) (E 43) (E 44) will be used according to the needs of the request inputs. One output (E 45) may be used according to the needs of a request. One input (E 46) enables the type of request to use to be defined:
1 Allocation request of a linear real memory block randomly positioned in the physical zone of the random access memory. This request is associated with a size by the input (E 43) and a permission type by the input (E 44) that may be reading, writing or execution. A random address creation request is made at the random number generation section (3x) by the output (I 47) to (E 36). The input (E 43) is then resent to (E 37) by the output (I 53) to report the random number (E 32) reports the random address that will be used. The neutral section (1x) is then activated by the output (I 51) to (I 12) to know through the input (I 52) from (I 13) if the input (E 41) has the right to allocate from the real linear memory (I 48). If the input (E 41) does not have the right to allocate from the real linear memory (E 48) then the output (E 50) is used, otherwise if the linear address (I 48) plus the size (E 43) does not create a collision, it is allocated and recorded with its size and its permissions in the neutral section (1x) by the output (I 49) to the input (I 11) of the neutral section (1x). The allocation section (4x) resends the input (E 48) to the output (E 45).
2 Allocation request of a linear real memory with a base address fixed in the physical zone of the random access memory. This request is associated with a memory address suggestion by the input (E 42), a size by the input (E 43) and a permission type by the input (E 44) that may be reading, writing or execution. Contrary to the allocation request from a random real linear memory, this request enables the processor to specify the base address (E 42) that it prefers to use. The neutral section (1x) is then activated by the output (I 51) to (I 12) to know through the input (I 52) from (I 13) if the input (E 41) has the right to allocate from the real linear memory (E 42). If the input (E 41) does not have the right to allocate from the real linear memory (E 42), then the output (E 50) is used, otherwise if the real linear address (E 42) plus the size (E 43) does not create a collision, the real linear memory is allocated and recorded with its size and its permissions in the neutral section (1x) by the output (I 49) to the input (I 11), the real and virtual linear allocation section (4x) resends the input (E 42) to the output (E 45).
3 Allocation request of a virtual linear memory randomly positioned in the physical zone of the random access memory. This request is associated with a size by the input (E 43) and a permission type by the input (E 44) that may be reading, writing or execution. A random address creation request is made at the random number generation section (3x) by the output (I 47) to (E 36). The input (E 43) is then resent to (E 37) by the output (I 53) to inform the random number generation section (3x) of the size requested. Then the input (I 48) from (E 32) reports the random address that will be used. The neutral section (1x) is then activated by the output (I 51) to (I 12) to know through the input (I 52) from (I 13) if the input (E 41) has the right to allocate from the virtual linear memory (I 48). If the input (E 41) does not have the right to allocate from the virtual linear memory (E 48) then the output (E 50) is used, otherwise if the linear address (E 48) plus the size (E 43) does not create a collision, it is allocated and recorded with its size and its permissions in the neutral section (1x) by the output (I 49) to the input (I 11), the real and virtual linear allocation section (4x) resends the input (E 48) to the output (E 45).
4 Destruction request from a virtual or real linear memory zone. This request is associated with an address by the input (E 42). The neutral section (1x) is activated by the output (I 51) to (I 12) to know through the input (I 52) from (I 13) if the input (E 41) has the right to destroy the memory address (E 42) and/or if it is valid. If the input (E 41) does not have the right to destroy the memory address (E 42) and/or if it is not valid, then output (E 50) is used, otherwise destruction information is sent to the neutral section (1x) by (I 49) to (I 11).
5 Request to change permission of a real or virtual zone. This request is associated with an address by the input (E 42) and a permission type by the input (E 44) that may be reading, writing or execution. The neutral section (1x) is then activated by the output (I 51) to (I 12) to know through the input (I 52) from (I 13) if the input (E 41) has the right to change permissions of the memory address (E 42) and if it is valid. If the input (E 41) does not have the right to change the permissions of the memory address (E 42) and/or if it is not valid then the output (E 50) is used, otherwise the permission changes are then updated in the neutral section (1x) by (I 49) to (I 11). An optional request to reallocate a zone already allocated may also be requested at the real and virtual linear allocation section (4x). Another optional request for a mirrored real or virtual linear memory from another real or virtual linear space may also be requested at the real and virtual linear allocation section (4x). FIG. 9e represents the real and virtual dynamic allocation section (6x). The dynamic memory also known as memory in the group is also part of the random access memory and has the special feature of being a memory zone particularly accessible by at least two procedures specific to it—memory request and memory deallocation. This dynamic memory is used, in particular, to store permanent variables. An input (E 61) enables the allocation section (6x) to be continuously informed of the position of the instruction cursor from the main processor or processors.
   The input (E 63) is used according to the needs of the request inputs. One output (E 64) may be used according to the needs of a request.
   One input (E 62) enables the type of request to use to be defined:
1 Allocation request of a dynamic real or virtual memory block randomly positioned in the physical zone of the random access memory. This request is associated with a size by the input (E 63). A random address creation request is made at the random number generation section (3x) by the output (I 68) to (E 36). The input (E 63) is then resent to (E 37) by the output (I 70) to inform the random number generation section (3x) of the size requested. Then the input (E 69) from (E 32) reports the random address that will be used. The neutral section (1x) is then activated by the output (I 66) to (I 12) to know through the input (I 67) from (I 13) if the input (E 61) has the right to allocate from the dynamic memory (E 69). If the input (E 61) does not have the right to allocate from the virtual linear memory (E 69) then the output (E 50) is used, otherwise if the linear address in input (E 69) plus the size in input (E 63) does not create a collision, it is allocated and recorded with its size and its permissions in the neutral section (1x) by the output (I 65) to the input (I 11), the real and virtual linear allocation section (4x) resends the input (E 69) to the output (E 64). It should be noted that the memory access management interface processor prevents specifying a base address during an allocation request from a real or virtual dynamic memory block. This voluntary approach allows totally random addresses, which are consequently undefined and secured, to be maintained.
2 Real or virtual memory deallocation request. This request is associated with an address by the input (E 63). The neutral section (1x) is activated by the output (I 66) to (I 12) to know through the input (I 65) from (I 13) if the input (E 61) has the right to destroy the memory address in input (E 63) and if it is valid. If the input (E 61) does not have the right to destroy the memory address (E 63) and/or if it is not valid, then output (E 50) is used, otherwise destruction information is sent to neutral section (1x) by (I 65) to (I 11).
   FIG. 9f represents the access management section (8x).
   An input (E 81) enables the access management section (8x) from the main processor (151) to the random access memory (155) to be continuously informed of the position of the instruction cursor from the main processor or processors (151). Two inputs (E 83) (E 84) will be used according to the needs of the request inputs. One output (E 88) may be used to indicate to the main processor if the copy or an execution is authorized. A copy verification request is requested by the main processor (151) via (E 82). This request is associated with inputs (E 83) and (E 84) that respectively designate the source and the destination. The neutral section (1x) is activated by the output (I 86) to (I 12) to know through the input (I 87) from (I 13) if the input (E 81) has the right to copy or not (E 83) in (E 84). If the input (E 81) does not have the right to copy (E83) in (E 84), then the output (E 85) is used, otherwise the output (E 88) informs the main processor that the copy is authorized. A jump or execution verification request is requested by the processor via input (E 82). This request is associated with input (E 83) that designates the address that the processor must execute. The neutral section (1x) is activated by the output (I 86) to (I 12) to know through the input (I 87) from (I 13) if the input (E 81) has the right to execute or not (E 83). If the input (E 81) does not have the right to execute (E82), then the output (E 85) is used, otherwise the output (E 88) informs the main processor that the execution is authorized.

The invention thus relates to a flow manager between the main processor (151) and the random access memory (155) characterized in that the flow manager comprises a memory access management interface processor (180) positioned in interface between the main processor (151) and random access memory (155), this memory access management interface processor (180) selecting the relevant flow characteristics with which it feeds an interface dedicated storage unit (190), the interface dedicated storage unit (190) being only accessible by the memory access management interface processor (180).

One can see that numerous variations possibly designed to be combined may be made here without ever departing from the scope of the invention as defined hereinafter.

One also sees that the invention is comprised of modules that, taken individually or in groups, may constitute an invention for some of them and are thus also protected by the present patent.
The embodiment of this invention is either hardware or logic.

1- A flow manager between the main processor (151) and the random access memory (155) characterized in that the flow manager comprises a memory access management interface processor (180) positioned in interface between the main processor (151) and random access memory (155), this memory access management interface processor (180) selecting the relevant flow characteristics with which it feeds an interface dedicated storage unit (190), the interface dedicated storage unit (190) being only accessible by the memory access management interface processor (180), the embodiment of this invention may be either hardware or logic.
